(19) United States
(12) Patent Application Publication
(10) Pub. No.: US 2014/0083469 A1
(43) Pub. Date: Mar. 27, 2014

(54) AUTOMATIC COKE REMOVER WITH SOLID-OF-REVOLUTION STRUCTURE

(71) Applicant: LUOYANG JIANGUANG PETROCHEMICAL EQUIPMENT CO., LTD, Luoyang, Henan (CN)

(72) Inventors: Zhiping Liu, Luoyang (CN); Zhonghai Lu, Luoyang (CN); Quingtao Yang, Luoyang (CN)

(73) Assignee: LUOYANG JIANGUANG PETROCHEMICAL EQUIPMENT CO., LTD, Luoyang, Henan (CN)

(21) Appl. No.: 14/007,235

(22) PCT Filed: Jan. 7, 2013
(86) PCT No.: PCT/CN2013/070138

§ 371 Date: Sep. 24, 2013

(30) Foreign Application Priority Data
Jan. 10, 2012 (CN) 201210005875.1

(51) Int. Cl. C10B 33/00; B08B 9/093

(52) U.S. Cl. CPC C10B 33/006; B08B 9/0936
USPC 134/110; 134/167 R

(57) ABSTRACT

An automatic coke remover with a solid-of-revolution structure, comprising a connector, a housing, a coke cutting nozzle, a drilling nozzle, and a pressure-controlled pilot valve, wherein an upper end of the housing is provided with a flange surface connected with the connector, an inner cavity of the housing butts a central hole of the connector to form a vertical high pressure waterway, the inner cavity of the housing is provided with a coaxial valve sleeve, the valve sleeve and a hollow piston disposed therein form a bi-directional hydraulic cylinder, the valve sleeve is provided with seal faces mating with upper and lower end faces of the hollow piston respectively.

### BACKGROUND

1. Technical Field

The present invention relates to hydraulic coke removers of delayed coking units in the petroleum refining industry, and in particular, to an automatic coke remover with a solid-of-revolution structure among hydraulic coke removers.

2. Related Art

Delayed coking is a petroleum processing technology, and takes heavy oil as the raw material, which is rapidly heated to a coking reaction temperature through a heating furnace, and enters into a coke tower for a coking reaction. The heavy oil is subject to deep thermal cracking and condensation reactions, and the produced gas, gasoline, diesel and gas oil pass through a pipeline to a downstream device and are processed in the downstream device; the produced hundreds of tons of coke are left in the coke tower. The coke in the coke tower is gradually cooled to below 120° C. with steam and water; upper and lower seal bonnets of the coke tower are then opened; a hydraulic coke remover is used to clean the coke in the coke tower, the upper and lower seal bonnets of the coke tower are closed, and then the process proceeds to a next production cycle: oil feeding, reaction, cooling, decoking, and so on.

The hydraulic coke remover usually includes: a decoking pump, a valve, a hose, a drill rod top drive, a drill rod, a coke remover, a winch, a pulley, and other devices. The decoking pump generates decoking water having certain energy, which passes through the valve, the hose, the drill rod top drive, and the drill rod into the coke remover, and is finally ejected from a nozzle of the coke remover. The coke remover has two groups of nozzles, i.e., drilling nozzles and cutting nozzles. Generally, when the hydraulic decoking begins, the drilling nozzle of the coke remover is used at first to eject the decoking water downward and drill a through hole with a diameter of about 1 m in the center of the coke tower, and the cutting nozzle of the coke remover is then used to eject decoking water toward two sides to gradually expand the channel; the coke is smashed in this process and flows out of the coke tower into a coke storage tank, and the decoking does not end until the coke in the coke tower is removed completely.

The drilling and coke cutting nozzles of the early coke remover are switched manually. Typically, blocking caps of the nozzles are screwed closed or open so that different nozzles eject water, or a manual switching valve is used to switch waterways so that different nozzles eject water. Anyway, in these operations, the coke cutter needs to be lifted out of the coke tower, and put into the coke tower to work upon completion of the manual switching. In 1996, Luoyang Petrochemical Engineering Corporation developed an automatic coke remover (Patent No.: 01216312.0). The coke remover, by using a decoking water pressure pulse signal, can remotely control switching of drilling and coke cutting of the coke remover, and the operation thereof is very safe and convenient. In the coke remover structure, a pressure-controlled pilot valve is used to switch a water supply channel, so that an internal piston goes up or down to switch drilling and coke cutting.

In the coke remover, to guarantee a sufficient operating range of the high pressure water ejected from the nozzle, the nozzle is provided with a rectifier, and the rectifier needs to have a sufficient length to ensure water flatness, so that the water ejected from the nozzle is not divergent and has a higher degree of aggregation. Limited by the length of the rectifier, the nozzles of the coke remover are usually exposed outside the shelf of the coke remover. When the coke in the coke tower collapses or the coke remover lifts the coke up, the protruding nozzle may increase a rotational resistance of the coke remover, the drill rod top drive has a heavy load and sometimes may be jammed. These phenomena not only damage the coke remover, but also greatly shorten the service life of the top drive.

Although attempts have been made to reduce the length of the nozzle protruding outside the housing, the implemented schemes are not successful due to the limitations of the minimum length of the rectifier and the size of the coke remover. For example, in the U.S. Patent US20090165618, the body of the nozzle is disposed in the housing, but the jet portion of the nozzle is still exposed outside due to the length requirement of the rectifier and the limitation of its own structure. Moreover, two cutting nozzles are asymmetrically disposed, and during cutting, an additional torque is generated due to the action of the injection pressure, which damages the drill rod top drive. Additionally, in the conventional design schemes, to avoid the portion of the nozzle in the housing from interfering with the operation of the nozzle switching device, the nozzle is prevented from being too close to the center of the coke remover, and the nozzle is away from the switching device. If, in this design, the housing completely wraps the nozzle, the size of the housing may be very large and too heavy, and this is also one reason why the nozzle of the coke remover is often exposed outside.

### SUMMARY

To technical problem to be solved by the present invention is to provide an automatic coke remover with a solid-of-revolution structure that has a small rotational resistance and is wear-resistant.

The technical solution adopted by the present invention to solve the technical problem is: an automatic coke remover with a solid-of-revolution structure, including a connector, a housing, a coke cutting nozzle, a drilling nozzle, and a pressure-controlled pilot valve, where an upper end of the housing is provided with a flange surface connected with the connector; an inner cavity of the housing butts a central hole of the connector to form a vertical high pressure waterway; the inner cavity of the housing is provided with a coaxial valve sleeve; the valve sleeve and a hollow piston disposed therein form a bi-directional hydraulic cylinder; the valve sleeve is provided with seal faces mating with upper and lower end faces of the hollow piston respectively; the housing and the connector are solids of revolution taking a center line of the high pressure waterway as an axis; a circumferential surface of the housing is at least provided with two coke cutting nozzle mounting holes; a lower surface of the housing is at least provided with four drilling nozzle mounting holes; an outer circumferential surface of the housing is further provided with a square or circular groove; the pressure-controlled pilot valve is disposed in the groove of the housing, and any part of the pressure-controlled pilot valve is located in space of the groove; the coke cutting nozzle is embedded in the coke cutting nozzle mounting holes of the housing, and any part of the coke cutting nozzle is located in space of the coke cutting nozzle mounting holes; the coke cutting nozzle is connected with a rectifier in the coke cutting nozzle mounting holes; the drilling nozzle is embedded in the drilling nozzle mounting holes of the housing, and any part of the drilling nozzle is located in space of the drilling nozzle mounting holes; a valve sleeve wall between upper and lower seal faces of the valve sleeve is provided with flow-through holes corresponding to the coke cutting nozzle and the drilling nozzle respectively; a water inlet of the pressure-controlled pilot valve communicates with the high pressure waterway through a flow channel in a housing wall and a flow channel hole on the valve sleeve; two water outlets of the pressure-controlled pilot valve communicate with two hydraulic cavities of the bi-directional hydraulic cylinder formed by the valve sleeve and the hollow piston through corresponding flow channels in the housing wall respectively; an aperture of the flow-through holes, opposite to the coke cutting nozzle, on the valve sleeve is greater than an outer diameter of the rectifier; one end of the rectifier is inserted into the corresponding flow-through hole, and a gap exists between an outer wall of the rectifier and an inner wall of the corresponding flow-through hole.

A lower end of the connector is provided with a flange; the flange is connected with the flange surface of the housing through a bolt; a gap is provided between the flange and the flange surface of the housing, and a lower end face of the connector is pressed on an upper end face of the valve sleeve.

The valve sleeve consists of an upper valve sleeve, a middle valve sleeve, and a lower valve sleeve; the upper valve sleeve, the middle valve sleeve and the lower valve sleeve are sequentially disposed in the inner cavity of the housing from top to bottom; the upper valve sleeve and the lower valve sleeve are each provided with seal faces mating with the upper and lower end faces of the hollow piston, and the middle valve sleeve foams an outer wall of the hydraulic cavities, where the wall thickness is less than that of the upper valve sleeve and the lower valve sleeve.

The center of the bottom of the lower valve sleeve is provided with a valve seat and a diversion cone, and the valve seat is provided with a seal face mating with a lower end of the hollow piston.

The circumferential surface of the housing is symmetrically provided with two coke cutting nozzle mounting holes, or three evenly distributed cutting nozzle mounting holes that are disposed at an interval of 120°. Each coke cutting nozzle mounting hole is provided with a coke cutting nozzle.

In the case where the circumferential surface of the housing is symmetrically provided two coke cutting nozzle mounting holes, the circumferential surface of the housing is further provided with two expansion holes; the two expansion holes and the two coke cutting nozzle mounting holes are disposed at an interval of 90° by taking the center line of the high pressure waterway as an axis; the expansion holes and the coke cutting nozzle mounting holes have the same shape and size; the expansion holes are provided with a blocking cap or the coke cutting nozzle therein, and the valve sleeve is provided with through holes corresponding to the expansion holes.

The coke cutting nozzle mounting holes and the expansion holes are provided with annular stepped surfaces for fixing the coke cutting nozzle, and the coke cutting nozzle is fixed in the coke cutting nozzle mounting holes or the expansion holes through a bolt.

On the valve sleeve, the flow channel hole opposite to a flow channel connecting the water inlet of the pressure-controlled pilot valve is provided with a filter screen.

The beneficial effects of the present invention are as follows: the shapes of the housing and the connector are solids of revolution taking the center line of the high pressure waterway as an axis; any part of the coke cutting nozzle, the drilling nozzle, and the pressure-controlled pilot valve does not protrude out of the outer surface of the housing; the coke remover has a compact structure and a small rotational resistance, and is not easily jammed by the coke during drilling, so the work efficiency is high and the damage to the nozzle and the top drive device is avoided. The rectifier of the coke cutting nozzle extends into the flow-through hole of the valve sleeve, which, without affecting the normal positioning of the valve sleeve, making the coke cutting nozzle close to the center of the coke remover maximally, reduces the size of the coke remover, and achieves overall protection by the housing over the coke cutting nozzle.

### BRIEF DESCRIPTION OF THE DRAWINGS

FIG. 1 is a schematic view of an embodiment of the present invention;

FIG. 2 is a schematic view of another embodiment of the present invention;

FIG. 3 is a schematic view of an embodiment of disposing two coke cutting nozzle mounting holes according to the present invention;

FIG. 4 is a schematic view of an embodiment of disposing two coke cutting nozzle mounting holes and two expansion holes according to the present invention; and

FIG. 5 is a schematic view of an embodiment of disposing three coke cutting nozzle mounting holes according to the present invention.

Reference signs: 1: Connector, 101: Central hole, 102: Flange, 2: Housing, 201: Flange surface, 202: Inner cavity, 203: Coke cutting nozzle mounting hole, 2031: Annular stepped surface, 204: Drilling nozzle mounting hole, 205: Groove, 206: Flow channel, 207: Expansion hole, 3: Coke cutting nozzle, 4: Drilling nozzle, 5: Pressure-controlled pilot valve, 501: Water inlet, 502: Water outlet, 6: High pressure waterway, 7: Valve sleeve, 701: Flow-through hole, 702: Flow channel hole, 703: Hydraulic cavity, 704: Seal face, 705: Upper valve sleeve, 706: Middle valve sleeve, 707: Lower valve sleeve, 7071: Valve seat, 7072: Diversion cone, 8: Hollow piston, 9: Blocking cap, 10: Filter screen, 11: Lower seal, 12: Seal ring, 13: Upper seal, 14: Rectifier.

### DETAILED DESCRIPTION

The setting modes and effects of the present invention are specifically described with reference to accompanying drawings and embodiments.

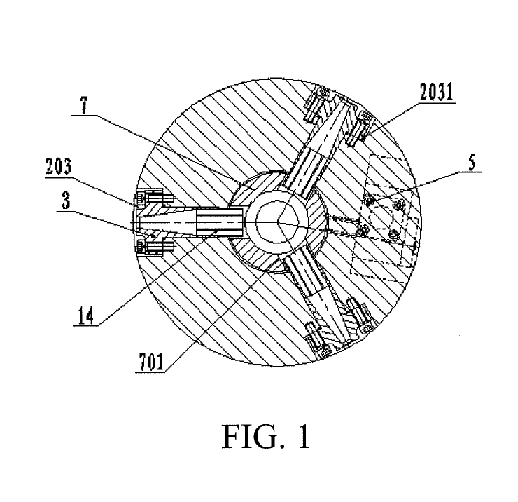

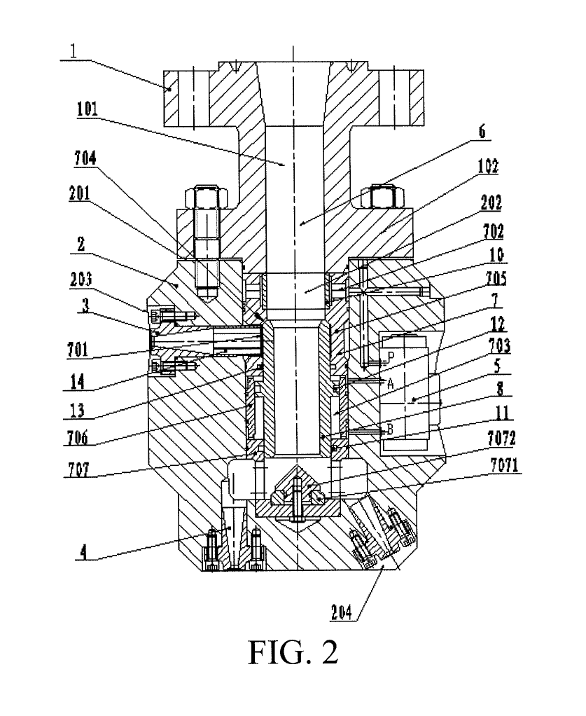

As shown in FIG. 1 and FIG. 2, an automatic coke remover with a solid-of-revolution structure includes a connector 1, a housing 2, a coke cutting nozzle 3, a drilling nozzle 4, and a pressure-controlled pilot valve 5. An upper end of the housing 2 is provided with a flange surface 201 connected with the connector 1. The connector 1 is connected with the housing 2 through a bolt, and an upper portion of the connector 1 is provided with a flange for connecting a top drive device drill rod, so as to fix the coke remover onto the drill rod. An inner cavity 202 of the housing 2 butts a central hole 101 of the connector 1 to form a vertical high pressure waterway 6. The inner cavity 202 of the housing 2 is provided with a coaxial valve sleeve 7, and an outer wall of the valve sleeve 7 is adhered to an inner wall of the inner cavity 202. A lower end of the connector 1 is provided with a flange 102, and the flange 102 is connected with the flange surface 201 of the housing 2 through a bolt. A gap is provided between the flange 102 and the flange surface 201 of the housing 2. A lower end face of the connector 1 is pressed on an upper end face of the valve sleeve 7 by a force of the bolt, so as to fix the valve sleeve 7 on the inner wall of the inner cavity 202 of the housing 2. The valve sleeve 7 and a hollow piston 8 disposed therein form a bi-directional hydraulic cylinder, and the hollow piston 8 can move up and down in the valve sleeve 7. The valve sleeve 7 is provided with seal faces 704 mating with upper and lower end faces of the hollow piston 8 respectively. The coke cutting nozzle 3 is disposed in coke cutting nozzle mounting holes 203 on a circumferential surface of the housing 2. The coke cutting nozzle 3 may be disposed horizontally as shown in FIG. 1, or disposed in an inclined manner as shown in FIG. 2. The drilling nozzle 4 is disposed in drilling nozzle mounting holes 204 at the bottom of the housing 2. A valve sleeve wall between upper and lower seal faces 704 of the valve sleeve 7 is provided with flow-through holes 701 corresponding to the coke cutting nozzle 3 and the drilling nozzle 4.

For the structure of the pressure-controlled pilot valve 5, reference may be made to the technical solution in Patent with Application No. 01216312.0. The pressure-controlled pilot valve 5 is provided with one water inlet and two water outlets. The pressure-controlled pilot valve 5 is disposed in a groove 205 on an outer surface of the housing 2, and a water inlet 501 of the pressure-controlled pilot valve 5 communicates with the high pressure waterway 6 through a flow channel 206 in a housing wall and a flow channel hole 702 on the valve sleeve 7. After water enters in the high pressure waterway 6, decoking water enters the water inlet 501 through the flow channel 206; the water inlet 501 provides water pressure switching power and a pulse signal of the pressure-controlled pilot valve, and is labeled as P port in the figure. When the pressure of the water inlet 501 disappears, a spring-driven valve core in the pressure-controlled pilot valve switches the state. Two water outlets 502 are output ports of the pressure-controlled pilot valve 5, and are labeled as A and B ports in the figure. At any time, only one of the A and B ports outputs the decoking water whose pressure is identical to that of the P port, the other one is open to the atmosphere to form a return passage. The two water outlets 502 of the pressure-controlled pilot valve 5 communicate with two hydraulic cavities 703 of the bi-directional hydraulic cylinder formed by the valve sleeve 7 and the hollow piston 8 through corresponding flow channels 206 in the housing wall.

In an embodiment of the present invention, the valve sleeve 7 consists of an upper valve sleeve 705, a middle valve sleeve 706, and a lower valve sleeve 707; the upper valve sleeve 705, the middle valve sleeve 706, and the lower valve sleeve 707 are sequentially disposed in the inner cavity 202 of the housing 2 from top to bottom. The upper valve sleeve 705 and the lower valve sleeve 707 are provided with seal faces 704 mating with the upper and lower end faces of the hollow piston 8 respectively, and the middle valve sleeve 706 forms an outer wall of the hydraulic cavities 703, whose wall thickness is less than that of the upper valve sleeve 705 and the lower valve sleeve 707. The manner of forming the valve sleeve 7 by means of butting can reduce the difficulty in processing parts, and facilitate assembling.

FIG. 1 shows that Port B outputs decoking water to a lower hydraulic cavity of the hollow piston 8 to move the hollow piston 8 upwards, until a conical seal face in the upper portion of the hollow piston 8 is closely adhered to the seal face in the middle portion of the upper valve sleeve 705, and the hollow piston 8 obscures the flow-through holes 701 communicating with the coke cutting nozzle 3. At this time, the decoking water enters into the drilling nozzle 4 through flow-through holes of the upper valve sleeve 705, the hollow piston 8, and the lower valve sleeve 707, and then is ejected from the drilling nozzle 4 for drilling.

FIG. 2 shows that port A outputs decoking water to an upper hydraulic cavity of the hollow piston 8, to move the hollow piston 8 downwards, until a conical seal face in the lower portion of the hollow piston 8 is closely adhered to the seal face of the lower valve sleeve 707. At this time, the flow-through hole through which the drilling nozzle 4 communicates with the central high pressure waterway 6 of the coke remover is cut off, and the decoking water from the connector 1 is ejected from the coke cutting nozzle 3 for coke cutting through the flow-through hole of the upper valve sleeve 705 and the rectifier 14.

To reduce the resistance during decoking, the solution that can be adopted is as follows: the housing 2 and the connector 1 are solids of revolution taking the center line of the high pressure waterway 6 as an axis, that is to say, the external shapes of both the housing 2 and the connector 1 are solids of revolution. A flange hole on the connector 1 and the coke cutting nozzle mounting holes 203, the drilling nozzle mounting holes 204, the groove 205, the flow channel, and the flow-through holes on the housing 2 are opened on the solid of revolution. A circumferential surface of the housing 2 is at least provided with two coke cutting nozzle mounting holes 203; a lower surface of the housing 2 is at least provided with four drilling nozzle mounting holes 204; an outer circumferential surface of the housing 2 is further provided with a square or circular groove 205; the pressure-controlled pilot valve 5 is disposed in the groove 205 of the housing 2; any part of the pressure-controlled pilot valve 5 is located in space of the groove 205. The coke cutting nozzle 3 is embedded in the coke cutting nozzle mounting holes 203 of the housing 2, and any part of the coke cutting nozzle 3 is located in space of the coke cutting nozzle mounting holes 203; the coke cutting nozzle 3 is connected with the rectifier 14 in the coke cutting nozzle mounting holes 203. The drilling nozzle 4 is embedded in the drilling nozzle mounting holes 204 of the housing 2, and any part of the drilling nozzle 4 is located in space of the drilling nozzle mounting holes 204. To reduce the diameter of the coke remover, an aperture of the flow-through holes 701, opposite to the coke cutting nozzle 3, on the valve sleeve 7 is greater than an outer diameter of the rectifier 14; one end of the rectifier 14 is inserted into the corresponding flow-through holes 701, and the port of the rectifier 14 may be flush with the inner surface of the valve sleeve 7. To prevent the rectifier 4 from affecting the mounting and positioning of the valve sleeve 7, a gap exists between an outer wall of the rectifier 14 and an inner wall of the corresponding flow-through holes 701, so as to press the valve sleeve 7 tightly in the inner cavity 202 of the housing 2 with activity allowance.

The number of the drilling nozzles 4 disposed at the lower end of the housing 2 is usually four, for example, the lower end of the housing 2 is provided with two vertically downward drilling nozzle mounting holes 204 and two obliquely downward; these drilling nozzle mounting holes 204 are evenly arranged symmetrically, and four drilling nozzles 4 are fixed in the drilling nozzle mounting holes 204 with bolts. To evenly distribute the decoking water into the drilling nozzles 4, the center of the bottom of the lower valve sleeve 707 is provided with a valve seat 7071 and a diversion cone 7072, and the valve seat 7071 is provided with a seal face mating with a lower end of the hollow piston 8. The decoking water is evenly distributed through the shunting effect of the diversion cone 7072.

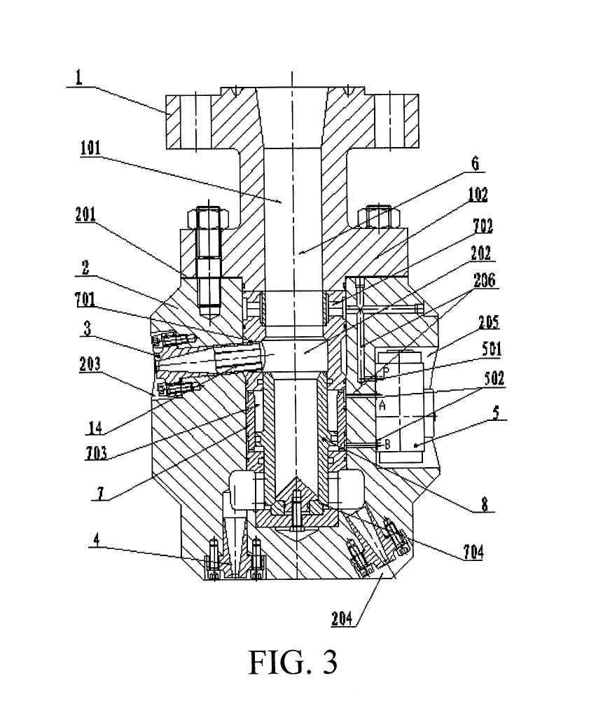

The circumferential surface of the housing 2 may be symmetrically provided with two coke cutting nozzle mounting holes 203 as shown in FIG. 3, or may be evenly provided with three coke cutting nozzle mounting holes 203 as shown in FIG. 5, and the three coke cutting nozzle mounting holes 203 are disposed at an interval of 120°. Each coke cutting nozzle mounting hole 203 is provided with a coke cutting nozzle.

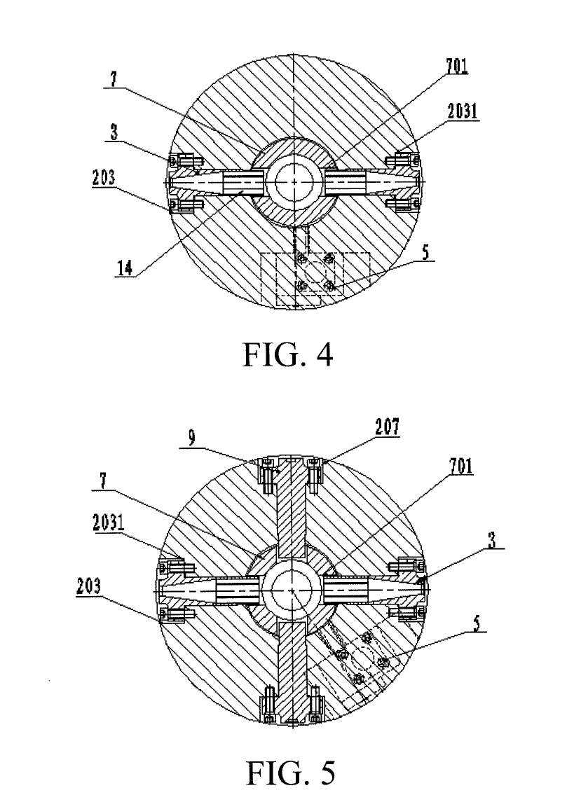

As shown in FIG. 4, in the case that the circumferential surface of the housing 2 is symmetrically provided with two coke cutting nozzle mounting holes 203, two expansion holes 207 may be further symmetrically provided, and the two expansion holes 207 and the two coke cutting nozzle mounting holes 203 are arranged at an interval of 90° by taking the center line of the high pressure waterway 6 as an axis, that is, the above four holes are distributed on the circumferential surface of the housing 2 at an interval of 90° like a cross. The expansion holes 207 and the coke cutting nozzle mounting holes 203 have the same shape and size. The expansion holes 207 are provided with a blocking cap 9 or the coke cutting nozzle 3, and the valve sleeve 7 is provided with through holes corresponding to the expansion holes 207. The two expansion holes 207 can be used when it is necessary to expand the number of the coke cutting nozzles 3. When the texture of the coke in the coke tower is soft, too large coke cutting pressure is not required, and an increase in the number of the coke cutting nozzles 3 can improve the decoking speed; at this time, the blocking cap 9 in the expansion holes 207 can be replaced with the coke cutting nozzle 3. When the texture of the coke in the coke tower is hard, large coke cutting pressure is required, and the pressure must be concentrated when the number of the coke cutting nozzle 3 is reduced; at this time, the coke cutting nozzle 3 in the expansion holes 207 is replaced with the blocking cap 9, and the expansion holes 207 is sealed with the blocking cap 9. Such a setting mode can conveniently adjust the coke remover, to adapt to different working conditions, which is a preferred setting mode. FIG. 3 and FIG. 4 further show the relative positions of the pressure-controlled pilot valve 5 and the coke cutting nozzle 3, and the groove of the pressure-controlled pilot valve 5 should not be mounted during the setting of the coke cutting nozzle mounting holes 203 and the expansion holes 207.

The coke cutting nozzle mounting holes 203 and the expansion holes 207 are provided with an annular stepped surface 2031 for fixing the coke cutting nozzle 3, and the coke cutting nozzle 3 is fixed in the coke cutting nozzle mounting holes 203 or the expansion holes 207 through a bolt. On the valve sleeve 7, the flow channel hole 702, which is opposite to a flow channel 206 connecting the water inlet 501 of the pressure-controlled pilot valve 5, is provided with a filter screen 10.

The lower valve sleeve 707 is provided with a lower seal 11; the hollow piston 8 is provided with a seal ring 12; the upper valve sleeve 705 is provided with an upper seal 13; and these components together form upper and lower hydraulic cavities of the hollow piston 8.

1. An automatic coke remover with a solid-of-revolution structure, comprising a connector, a housing, a coke cutting nozzle, a drilling nozzle, and a pressure-controlled pilot valve, wherein an upper end of the housing is provided with a flange surface connected with the connector, an inner cavity of the housing butts a central hole of the connector to form a vertical high pressure waterway, the inner cavity of the housing is provided with a coaxial valve sleeve, the valve sleeve and a hollow piston disposed therein form a bi-directional hydraulic cylinder, the valve sleeve is provided with seal faces mating with upper and lower end faces of the hollow piston respectively, wherein, the housing and the connector are solids of revolution taking the center line of the high pressure waterway as an axis, a circumferential surface of the housing is at least provided with two coke cutting nozzle mounting holes, a lower surface of the housing is at least provided with four drilling nozzle mounting holes, an outer circumferential surface of the housing is further provided with a square or circular groove the pressure-controlled pilot valve is disposed in the groove of the housing, and any part of the pressure-controlled pilot valve is located in space of the groove, the coke cutting nozzle is embedded in the coke cutting nozzle mounting holes of the housing, and any part of the coke cutting nozzle is located in space of the coke cutting nozzle mounting holes; the coke cutting nozzle is connected with a rectifier in the coke cutting nozzle mounting holes; the drilling nozzle is embedded in the drilling nozzle mounting holes of the housing, and any part of the drilling nozzle is located in space of the drilling nozzle mounting holes; a valve sleeve wall between upper and lower seal faces of the valve sleeve is provided with flow-through holes corresponding to the coke cutting nozzle and the drilling nozzle respectively; a water inlet of the pressure-controlled pilot valve communicates with the high pressure waterway through a flow channel in a housing wall and a flow channel hole on the valve sleeve, two water outlets of the pressure-controlled pilot valve communicate with two hydraulic cavities of the bi-directional hydraulic cylinder formed by the valve sleeve and the hollow piston through corresponding flow channels in the housing wall respectively, an aperture of the flow-through holes, opposite to the coke cutting nozzle, on the valve sleeve is greater than an outer diameter of the rectifier, one end of the rectifier is inserted into the corresponding flow-through holes, and a gap exists between an outer wall of the rectifier and an inner wall of the corresponding flow-through holes.

2. The automatic coke remover with a solid-of-revolution structure according to claim 1, wherein: a lower end of the connector is provided with a flange, the flange is connected with the flange surface of the housing through a bolt, a gap is provided between the flange and the flange surface of the housing, and a lower end face of the connector is pressed on an upper end face of the valve sleeve.

3. The automatic coke remover with a solid-of-revolution structure according to claim 1, wherein: the valve sleeve consists of an upper valve sleeve, a middle valve sleeve, and a lower valve sleeve; the upper valve sleeve, the middle valve sleeve, and the lower valve sleeve are sequentially disposed in the inner cavity of the housing from top to bottom; the upper valve sleeve and the lower valve sleeve are provided with seal faces mating with the upper and lower end faces of the hollow piston respectively, and the middle valve sleeve forms an outer wall of the hydraulic cavities, and a wall thickness of the outer wall is less than that of the upper valve sleeve and the lower valve sleeve.

4. The automatic coke remover with a solid-of-revolution structure according to claim 3, wherein: the center of the bottom of the lower valve sleeve is provided with a valve seat and a diversion cone, and the valve seat is provided with a seal face mating with a lower end of the hollow piston.

5. The automatic coke remover with a solid-of-revolution structure according to claim 1, wherein: the circumferential surface of the housing is symmetrically provided with two coke cutting nozzle mounting holes, and each coke cutting nozzle mounting hole is provided with a coke cutting nozzle.

6. The automatic coke remover with a solid-of-revolution structure according to claim 1, wherein: the circumferential surface of the housing is symmetrically provided with three coke cutting nozzle mounting holes, the three coke cutting nozzle mounting holes are disposed at an interval of 120°, and each coke cutting nozzle mounting hole is provided with a coke cutting nozzle.

7. The automatic coke remover with a solid-of-revolution structure according to claim 5, wherein: the circumferential surface of the housing is further symmetrically provided with two expansion holes, the two expansion holes and the two coke cutting nozzle mounting holes are disposed at an interval of 90° by taking the center line of the high pressure waterway as an axis, the expansion holes and the coke cutting nozzle mounting holes have the same shape and size, the expansion holes are provided with a blocking cap or the coke cutting nozzle, and the valve sleeve is provided with through holes corresponding to the expansion holes.

8. The automatic coke remover with a solid-of-revolution structure according to claim 1, wherein: the coke cutting nozzle mounting holes are provided with an annular stepped surface for fixing the coke cutting nozzle, and the coke cutting nozzle is fixed in the coke cutting nozzle mounting holes through a bolt.

9. The automatic coke remover with a solid-of-revolution structure according to claim 1, wherein: on the valve sleeve, the flow channel hole, opposite to a flow channel connecting the water inlet of the pressure-controlled pilot valve, is provided with a filter screen.
